(19) United States
(12) Patent Application Publication
(10) Pub. No.: US 2013/0266507 A1
(43) Pub. Date: Oct. 10, 2013

(54) MECHANOCHEMICAL PRODUCTION OF ZEOLITES

(71) Applicants: Jürgen Ladebeck, Bad Aibling (DE); Jürgen Koy, Grosskarolinenfeld (DE); Stephen Wellach, Laudenbach (DE); Josef Schönlinner, Obing (DE); Götz Burgfels, Bad Aibling (DE)

(72) Inventors: Jürgen Ladebeck, Bad Aibling (DE); Jürgen Koy, Grosskarolinenfeld (DE); Stephen Wellach, Laudenbach (DE); Josef Schönlinner, Obing (DE); Götz Burgfels, Bad Aibling (DE)

(73) Assignee: SUD-CHEMIE IP GMBH & CO. KG, Munchen (DE)

(21) Appl. No.: 13/988,598

(22) PCT Filed: Nov. 28, 2011
(86) PCT No.: PCT/EP11/71099

§ 371 Date: Jun. 18, 2013

(30) Foreign Application Priority Data
Dec. 1, 2010 (DE) 10 2010 053 054.9

(51) Int. Cl. B01J 29/70; B01J 29/40

(52) U.S. Cl. CPC B01J 29/7007; B01J 29/40
USPC 423/704; 423/700

(57) ABSTRACT

The subject of the invention is a method for the synthesis of zeolites, comprising the following steps: a) providing a silicon source; b) providing an aluminium source; c) optionally providing at least one template; d) mixing the silicon source, aluminium source and optional template in order to produce a synthesis gel; e) grinding the synthesis gel; f) treating the ground synthesis gel under hydrothermal conditions in order to produce crystalline zeolite, as well as zeolites that can be obtained according to this method. The products obtained according to the method can be used as catalysts or catalyst supports.

The invention relates to a method for the production of zeolites, as well as zeolites that can be obtained by this method.

### Background to the invention

Zeolite materials can be produced by hydrothermal synthesis, i.e. by synthesis in an aqueous medium under pressure and at an increased temperature. Via hydrothermal synthesis, synthesis gels are crystallized to the corresponding zeolites. The synthesis gels usually comprise a silicon source (e.g. silicic acid), an aluminium source (e.g. sodium aluminate, aluminium hydroxide, aluminium sulphate, etc.), a template (preferably a quaternary ammonium compound, which serves as structure-directing agent) and water.

However, the known synthesis methods have the disadvantage that the crystallization time of the zeolites in the case of hydrothermal synthesis is relatively long and the obtained zeolites frequently do not represent uniform substances, but mixtures.

The object of the invention was therefore to provide a method that makes it possible, with a simple method and short crystallization times, to obtain crystalline zeolite, in particular zeolite with high phase purity.

Numerous tests were carried out by the inventors, in order to discover such a method. It was surprisingly found that an additional grinding step, carried out after the production of the synthesis gel, shortens the crystallization time and leads to zeolites with a high phase purity. Alternatively this additional method step makes it possible to reduce the quantity of template used without damaging the phase purity, which significantly reduces the production costs. The present invention was realized on the basis of this finding.

The invention relates to a method for the synthesis of zeolites, which comprises the following steps: a) providing a silicon source; b) providing an aluminium source; c) optionally providing at least one template; d) mixing the silicon source, aluminium source and optional template in order to produce a synthesis gel; e) grinding the synthesis gel; f) treating the ground synthesis gel under hydrothermal conditions in order to produce crystalline zeolite.

In a further aspect the present invention relates to zeolites that can be obtained with the method according to the invention. Preferably beta zeolite and MFI zeolite are produced; particularly preferably beta zeolite with an Si:Al molar ratio of from 10 to 400, even more preferably from 20 to 50, and MFI zeolite with an Si:Al molar ratio of from 12 to 800, even more preferably from 24 to 500 and particularly preferably from 75 to 250.

In addition the present invention teaches the use of at least one grinding device for treating a synthesis gel, comprising a silicon source, an aluminium source and optionally at least one template, before the production of crystalline zeolite under hydrothermal conditions.

Furthermore the present invention teaches the use of the zeolites that can be obtained according to the method according to the invention as catalysts or catalyst supports, in particular for acid-catalyzed reactions, oxidations, reductions and adsorptions. Particularly preferred is the use for catalytic cracking of hydrocarbons (cracking) and hydrogenation cracking of hydrocarbons (hydrocracking, mild hydrocracking and/or dewaxing); alkylation of aromatics with olefins, alcohols or halogen-containing paraffins; alkylation of aromatics; alkylation of isoparaffins with olefins; transalkylation (in particular of aromatics); disproportionation; isomerization; hydroisomerization; dimerization; oligomerization; polymerization; etherification; esterification; hydration; dehydration; adsorption; condensation; oxidation; acetalation; dealkylation and cyclization.

The invention generally relates to a method for the production of zeolites, wherein a synthesis gel is first produced from a silicon source, an aluminium source and optionally at least one template. The production of the synthesis gel by mixing silicon source, aluminium source and optionally one or more templates can take place in a way known to a person skilled in the art based on the teaching of the present invention. The silicon source, aluminium source and the one or more templates can be mixed together as such or in fluid form, for example as solution, suspension or gel, or added to a solvent or solvent mixture. Water or an aqueous solvent mixture is preferably used as solvent. The silicon source, the aluminium source, the optional template and/or the synthesis gel can in particular be present in aqueous medium.

The step of mixing silicon source, aluminium source and optionally one or more templates preferably involves thorough mixing or homogenization.

Particularly good results can be achieved if the silicon source is a silicon source selected from the group consisting of precipitated silicic acid, colloidal silicic acid and mixtures thereof. The silicon source can in particular contain precipitated silicic acid or consist thereof. The aluminium source can be an aluminium source selected from the group consisting of aluminates (in particular sodium aluminate), aluminium hydroxide, aluminium sulphate and mixtures thereof. Any template based on the common general knowledge of the skilled person or the teaching of the present invention can be used as template, wherein preferably quaternary ammonium compounds that can serve as structure-directing agents are used as template. Tetraalkyl ammonium salts are examples of templates that can be used. The use of tetraalkyl ammonium hydroxides and/or tetraalkyl ammonium bromides, wherein the alkyl groups are preferably identical or different, straight-chain or branched alkyl groups with one to ten (preferably one to four) carbon atoms, is preferred. The use of tetraethyl ammonium hydroxide (TEAOH) or tetrapropyl ammonium bromide (TPABr) is particularly preferred. The template is used for example in a quantity of 1 to 50 mol. %, in particular in a quantity of 10 to 30 mol. %, preferably in a quantity of 4 to 20 mol. %, relative to the molar quantity of Si in the silicon source. One or more templates can be used; the use of one template is preferred.

In the synthesis of MFI-zeolite (zeolite ZSM-5) the synthesis gel can have a molar ratio of Al to Si for example in the range from 0.00125:1 to 0.0833:1, preferably in the range from 0.002:1 to 0.0416:1, particularly preferably in the range from 0.004:1 to 0.0133:1 and/or a molar ratio of Na to Si in the range from 0.01:1 to 0.2:1, preferably from 0.02:1 to 0.15:1, particularly preferably 0.04:1 to 0.14:1. The synthesis gel preferably comprises, per 1 mol of SiO₂, at least 10 mol of water, even more preferably 18 to 30 mol of water.

In the synthesis of beta zeolite (BEA) the synthesis gel can have a molar ratio of Al to Si for example in the range from 0.0025:1 to 0.1:1, preferably in the range from 0.02:1 to 0.08:1 and/or a molar ratio of Na to Si in the range from 0.001:1 to 0.1:1, preferably in the range from 0.01:1 to 0.08:1. Preferably the synthesis gel comprises, per 1 mol of SiO₂, at least 5 mol of water, even more preferably 10 to 50 mol of water.

The production of the synthesis gel is followed by a grinding of the synthesis gel, as explained in detail below. Within the context of the present invention the term “synthesis gel” covers both synthesis gels that are present in the form of a gel-like or gelatinous mass and those present in fluid form, for example in the form of a suspension. The ground synthesis gel is then transferred to the crystalline zeolite under hydrothermal conditions, and the crystalline zeolite can then be separated from the aqueous phase and optionally dried and calcined.

The method according to the invention is explained below with reference to the synthesis of beta zeolite and MFI zeolite, but is not limited to the synthesis of these zeolites.

The zeolites that can be obtained by the method according to the invention preferably have a phase purity of more than 80%, preferably more than 90%, preferably more than 95%, in particular more than 98%. The phase purity is determined by an X-ray diffraction measurement and is relative to a 100% pure sample.

The grinding of the synthesis gel before treatment under hydrothermal conditions can lead to an increase in the dispersion of the silicon source used, e.g. of a precipitated silicic acid, which can in turn lead to acceleration of the crystallization process. In addition, the formation of foreign phases can surprisingly be inhibited or suppressed. In this way the quantity of template necessary for the synthesis can optionally also be reduced, leading to a reduction in production costs.

Furthermore, according to a preferred embodiment, because of the grinding process following the synthesis gel production, the colloidal silicic acids can be partially or completely replaced by the substantially cheaper precipitated silicic acids. A further significant reduction in the production costs of such zeolites can thereby be achieved, the production of which usually uses colloidal silicic acid sources as raw material. Furthermore, preferably no zeolite seed crystals are required, in particular in the production of beta zeolite, whereby the production costs can also be reduced.

Moreover, in the production of the synthesis gel, mother liquors can also be used instead of highly pure starting materials. The first filtrate following the separation of the solid from the synthesis gel after completion of the zeolite synthesis is described as mother liquor. This first filtrate still contains raw materials which were not converted during the zeolite synthesis, as well as a proportion of solid.

Grinding is preferably carried out such that the average particle size d₅₀ of the synthesis gel after completion of the grinding is at least 10%, further preferred at least 15%, preferably at least 20%, smaller than the average particle size d₅₀ of the synthesis gel at the start of the grinding.

The grinding can generally be carried out with any suitable grinding device. During the grinding a high quantity of energy (for example approximately 0.5 to 10 kW/litre, preferably approximately 1 to 10 kW/litre) is introduced into the system via the mechanical energy. In the final stage of the grinding, according to a preferred embodiment, the quantity of energy can be reduced, for example to 2 to 5 kW/litre.

During the grinding, a significant reduction in viscosity can take place, wherein according to a preferred embodiment according to the invention the viscosity of the synthesis gel after completion of the grinding is for example at least 10%, preferably at least 15%, further preferably at least 20% less than the viscosity of the synthesis gel at the start of the grinding.

According to a further embodiment the starting materials, in particular the starting materials that are insoluble in the aqueous phase, are also subjected to intensive grinding before the production of the synthesis gel. It is further preferred that, before the production of the synthesis gel, the silicon source and/or the aluminium source, unless these are present in solution form, are subjected to grinding.

During the production of the synthesis gel by mixing and up to the start of the grinding, optionally also during part of or throughout the entire duration of grinding, the synthesis gel is preferably placed under a pressure of not more than 2.4 bar, further preferably under a pressure of not more than 1.9 bar, even more preferably under a pressure of not more than 1.5 bar, most preferably under a pressure of not more than 1.1 bar and/or preferably heated to a temperature of not more than 128° C., further preferably not more than 110° C., even more preferably not more than 100° C., most preferably not more than 70° C., and quite particularly preferably not more than 35° C.

The grinding is preferably carried out at a temperature between approximately 0° C. and 100° C., in particular between approximately 0° C. and 50° C., wherein the synthesis gel is pumped for example through a grinding chamber filled with grinding balls.

According to a preferred embodiment the grinding is carried out in a mill comprising a grinding chamber filled with grinding balls, for example in a ball mill, in an annular gap mill, a bead mill, a Manton-Gaulin mill or in a grinding device combination comprising one or more of these grinding devices. A multistage grinding device can preferably be used, for example a multistage ball or annular gap mill, in which the coarse portions from the last step are returned to the first step again. Further preferably the one or more grinding devices can include at least one grinding device, selected from the group consisting of mills comprising a grinding chamber filled with grinding balls, in particular selected from ball mills, annular gap mills, bead mills, Manton-Gaulin mills and combinations thereof. A Manton-Gaulin mill is for example explained in detail in U.S. Pat. No. 4,664,842, wherein the disclosure regarding same in the specification is included in the present application by way of reference.

A person skilled in the art can select alternative grinding devices on the basis of his common general knowledge. If desired, several different or identical grinding devices can also be used in succession or simultaneously.

Higher temperatures, i.e. of more than 100° C. are optionally also possible if the grinding process is carried out under excess pressure. In this case the inflow and outflow of the synthesis gel into and out of the grinding chamber must also be regulated.

The pH of the synthesis gel is set corresponding to the synthesis conditions and is generally approximately 9 to 14. In particular the grinding can be carried out at a pH in the range from approximately 9 to 14, preferably approximately 10 to 13. The pH can be set according to a procedure known to a person skilled in the art, for example by adding acids, bases and/or buffer salt mixtures.

The synthesis gel or the reaction mixture obtained therefrom can be conveyed through the grinding chamber in several passes or with a longer residence time. The synthesis gel or the reaction mixture formed therefrom can additionally contain zeolite precursors as crystal nuclei and can then be subjected to a subsequent hydrothermal treatment, wherein the obtained product is optionally separated from the reaction mixture, dried and optionally calcined. In particular, after production under hydrothermal conditions, the obtained crystalline zeolite can be separated, dried and optionally calcined.

According to a further embodiment the grinding is carried out twice or more frequently, e.g. twice, three times or four times.

Due to the grinding of the educts or the crystal nuclei that have formed, the course of the hydrothermal zeolite synthesis is optimized with respect to synthesis time, flexibility as regards the selection of the educts, yield, degree of crystallization and phase purity. According to a preferred embodiment the introduction of the grinding process allows zeolite synthesis using a small quantity of template.

The synthesis gel or the reaction mixture obtained therefrom can be pumped through the grinding chamber. According to an embodiment, the suspension obtained after grinding, with the crystal nuclei, is then further processed in the usual way under hydrothermal conditions and worked up to the finished product. According to a possible embodiment a precipitation process and an ageing process (crystallization of the catalyst precursor) are optimized by the use of crystal nuclei.

In the method according to the invention the raw materials (a silicon source, an aluminium source and an alkali source) are for example stirred together with a template and completely demineralized water to produce a suspension. The suspension is passed through one or more grinding devices as indicated herein.

The mechanically activated fines act as crystal nuclei in the subsequent hydrothermal treatment. After this treatment the crystalline zeolite is separated from the suspension, dried and optionally calcined. The drying can be carried out at a temperature of approximately 60 to 200° C., preferably approximately 80 to 150° C., for e.g. 0.5 to 10 hours, and the calcining, if provided, at approximately 250 to 750° C., preferably 300 to 550° C., for e.g. 1 to 10 hours.

The thus-obtained product can be used as catalyst or catalyst support.

The present invention teaches in particular the use of at least one grinding device for treating a synthesis gel comprising a silicon source, an aluminium source and optionally at least one template, in a step before the production of crystalline zeolite under hydrothermal conditions. This use can serve to improve the phase purity and/or crystallinity of the zeolite produced.

According to a further aspect the present invention provides a zeolite that can be obtained according to the method according to the invention. In particular the zeolite can be an MFI zeolite, in particular with an Si:Al molar ratio in the range from 12 to 800, preferably 24 to 500, particularly preferably 75 to 250, or a beta zeolite.

Catalytically active forms of the zeolites, for example of the beta zeolite and MFI zeolite can additionally contain metals of groups IA, IIA, IIIA to VIIIA, IB, IIB or IIIB of the periodic table as well as B, Al, Ga, Si, Ge or P, preferably Li, Na, K, Mg, Ca, Ba, La, Ce, Ti, Zr, Nb, Ta, Mo, W, Mn, Re, Fe, Ru, Co, Rh, Ni, Pd, Pt, Cu, Zn, B, Al, Ga, Si, Ge or P. Particularly preferably the catalytically active zeolites contain one or more of the following: Pt, Pd, Cu, Fe, Rh, Ru, P and Ni. For example the exchange can take place with the help of ion exchange processes, impregnation or physical mixing processes. Further processes for the exchange of the original cations are familiar to a person skilled in the art and are therefore not explained in more detail here.

Depending on the desired use, the zeolites obtained according to the method according to the invention can be mixed with further components or further processed. Preferred further processing of the zeolite includes aqueous ion exchange, solid-state ion exchange (as described for example in EP 0 955 080 A), dealuminization for example by treatment with diluted mineral acid or a diluted organic acid, as well as by hydrothermal treatment (see e.g. R. Szostak, Studies in Surface Science Catalysis, 137 (2001) 261-297), production of shaped bodies of any size and shape by conventional processes such as extrusion, tabletting or spray drying, optionally with the aid of binders, or coating of shaped bodies, in particular honeycombs, with a suspension of zeolite and binder as so-called washcoat.

The synthetic zeolites according to the invention can in particular be used as catalysts, wherein for example the zeolites can be used in the H Form (with or without coating with non-noble metals and/or noble metals) as catalysts for acid-catalyzed reactions, oxidations, reductions and adsorptions.

These reactions include, among other things, catalytic cracking (FCC additive) and hydrogenation cracking of hydrocarbons (mild hydrocracking, dewaxing, hydrocracking); alkylations e.g. of aromatics with olefins, alcohols or halogen-containing paraffins; alkylation of aromatics; alkylation of isoparaffins with olefins; transalkylation (of aromatics); disproportionation (e.g. toluene disproportionation, etc.); isomerization and hydroisomerization (e.g. of paraffins, olefins, aromatics, xylene isomerization, isodewaxing, etc.); dimerization and oligomerizations; polymerizations; etherifications and esterifications; hydration and dehydration; adsorption; condensation; oxidation; acetalation; dealkylation and cyclization; alkylation and hydrodealkylation (ethylbenzene to benzene); exhaust-gas purification; acid-catalyzed reactions are for example also indicated in DE-A-4 405 876, wherein a catalyst based on a particulate acid-activated layer silicate, in which the particles are bound together by a binder, is used.

The method according to the invention is described below with reference to examples, in non-limitative manner.

### Methods

### a) Determination of Viscosity

The viscosity of the pastes or suspensions or dispersions was measured according to DIN 53019/ISO 3219. A Rheo-Stress 600 rheometer from Haake was used in accordance with the manufacturer's instructions.

### b) Average Particle Diameter

The average diameter d₅₀ is defined such that 50% of the total particle volume consists of particles with a smaller diameter. A suitable method for determining the particle size distribution is for example laser diffraction according to ISO 13320-1.

### c) Loss on Ignition

The loss on ignition is determined as follows: Clean porcelain crucibles are annealed at 600° C. and then kept in a desiccator until used. The homogenized sample is weighed into a porcelain crucible and the crucible is then annealed at 1000° C. in a conventional laboratory muffle furnace for 3 hours. The crucible is then placed in a desiccator to cool down. The loss on ignition can be calculated by comparing the initial weight and the final weight. The loss on ignition is always ascertained by a double determination.

### d) Chemical Composition of the Zeolites

In order to ascertain the chemical composition of the zeolites, zeolites heated beforehand at 1000° C. to constant weight and then cooled to 20° C. are used. In order to ascertain the Si and Al content, a conventional elemental analysis can be carried out.

The value n_{Si}/n_{Al} indicates the ratio of the amount of Si in mol to the amount of Al in mol, wherein the respective zeolite was previously subjected to heating at 1000° C. to constant weight.

In the event that there are several versions of a standard (e.g. DIN, ISO, ASTM standards etc.) this application refers to the standard current on 1^{st} Oct. 2008, unless another version is explicitly indicated, deviating from this.

e) Phase and/or Crystallization Determination of Zeolites

With this method, crystalline solids are examined with respect to their lattice structure. An X-ray diffractogram is taken in each case of the sample to be examined and the corresponding reference sample in immediate succession in time. Comparison of the reflexes of the entire spectrum, in particular with reference to the line width of the reflex at approximately 22.4° 2-theta provides information on the phase purity and/or degree of crystallization of the sample. A D4 Endeavor device from Bruker was used for determination of the X-ray diffractogram.

### EXAMPLES

### a) Provision of the Aluminium Source

Sodium aluminate was used as aluminium source, wherein an aqueous aluminium source was produced by dissolving sodium aluminate (and in the case of Example or comparison example 4 additionally NaOH beads) in water. In order to completely dissolve the sodium aluminate, the mixture was heated to 60-100° C. After the solid had dissolved, the yellowish, slightly cloudy fluid was cooled to room temperature and the mass loss corrected by addition of demineralized water.

### b) Provision of the Silicon Source and the (at Least One) Template

During the production of the silicon source, in the case of beta zeolite (BEA) the template tetraethyl ammonium hydroxide (TEAOH, SACHEM) was first mixed with water at room temperature or in the case of MFI zeolite the template tetrapropyl ammonium bromide (TPABr, SACHEM) was first dissolved in water at room temperature. The template tetraethyl ammonium hydroxide used was used as solution with 35 wt. % TEAOH. The tetrapropyl ammonium bromide was used as solid with >99 wt. % TPABr. Precipitated silicic acid (FK320, Degussa) was then introduced by slurrying.

### c) Mixing of the Aluminium and Silicon Sources and Production of the Synthesis Gel

In this synthesis step the aluminium source was continuously added to the silicon source in a reaction container at room temperature (20° C.) accompanied by mixing. The obtained suspension was mixed for a further 140 minutes (in the case of the production of beta zeolite) or 30 minutes (in the case of the production of MFI zeolite) at room temperature (20° C.)

All 10 synthesis tests took place identically up to this work step. The synthesis batches according to Examples 1 to 4, unlike comparison examples 1 to 4, were subjected to a further production step, grinding in a stirred ball mill.

### d) Grinding in the Stirred Ball Mill

For this purpose the corresponding synthesis gels were conveyed into the grinding chamber of the ball mill (type Fryma M32) with a hose pump. After the grinding chamber was filled, the rotor of the mill was started and the complete synthesis gel pumped through the grinding chamber with the rotor running. The ground product was collected in a container and subjected to a second grinding stage. The pumping rate was 3 litres/minute (BEA and MFI).

It was to be observed here that the viscosity of the synthesis gel changed drastically in the case of beta zeolite. In the case of beta zeolite the suspension had an average viscosity at the start and a suspension with lower viscosity was obtained after the grinding.

### e) Filling of the Autoclave and Crystallization

For the synthesis of the zeolites a 10-litre autoclave was filled with 9 kg of the synthesis gels in each case. The autoclave was then closed, the stirrer started and heating of the synthesis gels begun.

### f) Crystallization Conditions

The syntheses were carried out in the autoclave under dynamic conditions at 150° C. The crystallization times were between 1 h and 160 h depending on the batch.

| | BEA | MFI |
|---|---|---|
| Heating period (h): | 10 | 12 |
| Stirring speed (rpm): | 73 | 73 |
| Synthesis pressure (bar): | >10 | 3.7-4.5 |
| Crystallization temperature (° C.): | 150 | 150 |
| Crystallization period (h): | 10-160 | 1-10 |
| Type of stirrer: | anchor | anchor |

### g) Working Up the Synthesis Products

All the synthesis products were worked up by repeated washing with demineralized water using a Buchner funnel, resuspension (conductivity<90 μS/cm) and drying at 120° C. over 16 h.

### Results

Table I gives an overview of the various template contents of the ground or unground synthesis gels and the obtained products.

Molar composition of the synthesis gels used:

### BEA:

(0.08-0.18) TEAOH:0.04 Na₂O:0.04 Al₂O₃:1 SiO₂:12 H₂O

### MFI:

0.055 TPABr:0.0675 Na₂O:0.0014 Al₂O₃:1 SiO₂:24.5 H₂O

TABLE I
Template content of the synthesis gels and products

| | Molar*⁾ | Ground | |
|---|---|---|---|
| | template | synthesis | |
| | content | gel | Product |
| Ex. 1 | 0.08 | yes | BEA |
| Comp. Ex. 1 | 0.08 | no | BEA**⁾ |
| Ex. 2 | 0.12 | yes | BEA |
| Comp. Ex. 2 | 0.12 | no | BEA |
| Ex. 3 | 0.18 | yes | BEA |
| Comp. Ex. 3 | 0.18 | no | BEA |
| Ex. 4 | 0.055 | yes | MFI |
| Comp. Ex. 4 | 0.055 | no | MFI |

*⁾The molar template content, as shown in Table I, is indicated relative to the molar Si content. A molar template content of 0.18 signifies for example that the ratio of the quantity of template in mol to the quantity of Si in mol is 0.18:1 = 0.18 i.e. 18 mol. %.
**⁾Beta-zeolite with a small quantity of MFI zeolite impurities, determined by X-ray diffraction measurement.

The syntheses with ground synthesis gels led to phase-pure zeolites. The zeolites obtained from the unground synthesis gels contained impurities in one case. The syntheses according to Examples 1 to 4 or comparison examples 2 to 4 led to the desired synthesis products BEA and MFI in each case. In the case of beta zeolite the use of non-ground synthesis gel resulted in a small quantity of MFI zeolite impurity (Comp. Ex. 1) in one case.

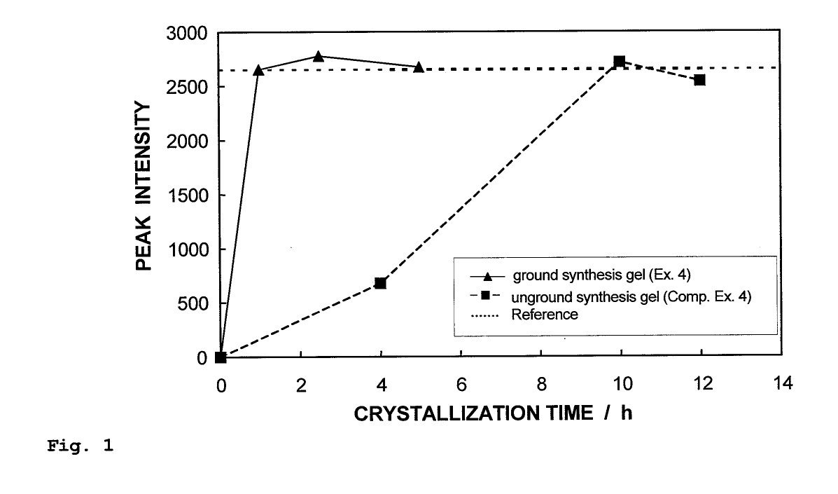

FIG. 1 shows a significant reduction in the crystallization time in the case of the synthesis of MFI zeolite when using ground synthesis gel (Example 4) compared with unground synthesis gel (comparison example 4) of 1 hour compared with 9 hours. The progress of the crystallization was determined by ascertaining the peak intensity of a synthesis gel or reaction mixture sample by means of X-ray diffraction measurement. The product of Example 4 (MFI zeolite) furthermore shows a significant reduction in the crystallite size of the primary crystallites. Although the shape of the primary crystallites is retained, the crystallite length is reduced from approximately 3.8 μm to approximately 1.2 μm, i.e. to approximately 32%. This effect can be attributed to the fact that due to the grinding of the synthesis gel a larger number of seed crystals is formed on which the actual zeolite grows in the crystal growth phase.

The chemical composition of the obtained products is indicated in Table II.

TABLE II
Chemical composition of the products

| | WL^{a)} | Si^{b)} | Al^{b)} | | | | Fe^{b)} | |
|---|---|---|---|---|---|---|---|---|
| Sample | 1000° C. | [wt. %] | [wt. %] | nₛᵢ/n_{Al} | Na^{b)} | | [ppm] | C^{b)} |
| Ex. 1 | 18.9 | 44.02 | 3.45 | 12.25 | 2040 | ppm | 410 | 12.4 wt. % |
| Comp. | 18.4 | 43.14 | 3.48 | 11.91 | 1920 | ppm | 310 | 12.1 wt. % |
| Ex. 1 | | | | | | | | |
| Ex. 2 | 20.0 | 43.13 | 3.26 | 12.70 | 490 | ppm | 440 | 13.8 wt. % |
| Comp. | 29.8 | 45.73 | 3.38 | 13.01 | 610 | ppm | 260 | 14.0 wt. % |
| Ex. 2 | | | | | | | | |
| Ex. 3 | 19.9 | 44.57 | 3.45 | 12.43 | 800 | ppm | 570 | 13.7 wt. % |
| Comp. | 21.3 | 43.71 | 3.43 | 12.24 | 560 | ppm | 250 | 14.4 wt. % |
| Ex. 3 | | | | | | | | |
| Ex. 4 | 14.4 | 47.43 | 0.25 | 185.7 | 0.84 | wt. % | 690 | 9.79 wt. % |
| Comp. | 14.2 | 47.09 | 0.20 | 228.3 | 0.84 | wt. % | 260 | 9.50 wt. % |
| Ex. 4 | | | | | | | | |

^{a)}weight loss at 1000° C.
^{b)}based on weight loss at 1000° C.

With reference to the results obtained it is clear that both the grinding and the template content in the synthesis gel have a significant influence on the crystallization times of the zeolites. By grinding the synthesis gels, as well as by means of a higher template content a shortening of the crystallization period can be achieved. By grinding the synthesis gels it is possible to achieve a crystallization time which is for example 5 to 80% shorter, frequently at least 50% shorter, compared with direct synthesis without a grinding process.

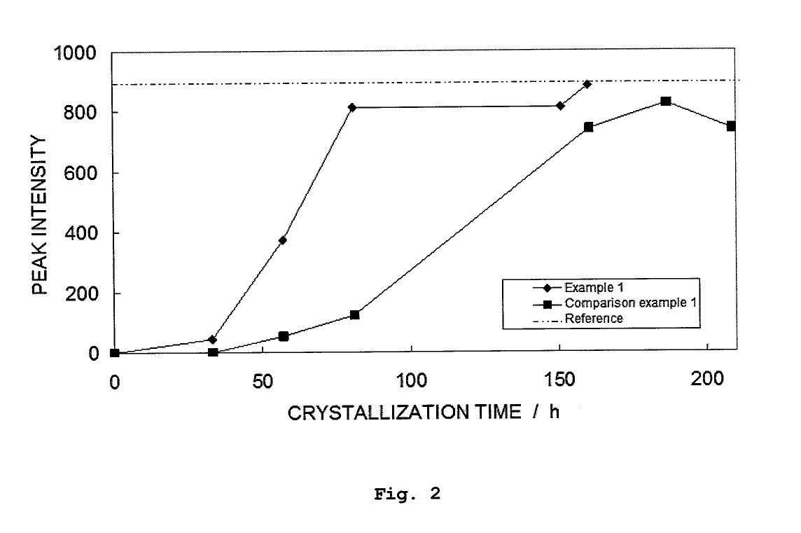

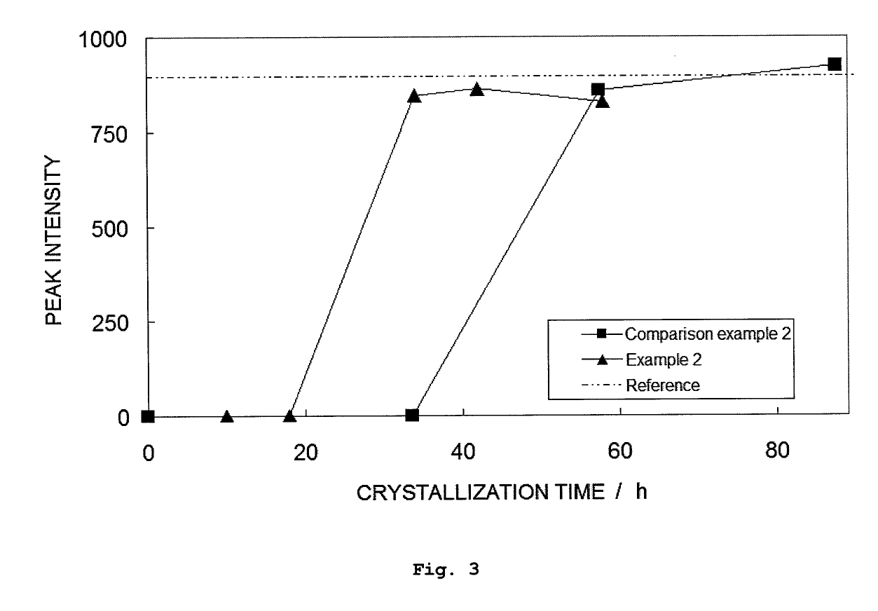

FIG. 2 shows a comparison of the crystallization times in the case of syntheses with ground (Example 1) and unground (comparison example 1) synthesis gels (molar template content relative to the molar Si content=0.08) and FIG. 3 shows a comparison of the crystallization times in the case of syntheses with ground (Example 2) and unground (comparison example 2) synthesis gels (molar template content relative to the molar Si content=0.12).

The progress of the crystallization was determined by ascertaining the peak number of a synthesis gel sample by means of X-ray diffraction measurement.

The use of a precipitated silicic acid (FK320) makes it possible to achieve results almost as good as those achieved with use of a colloidal silicic acid (LUDOX® from Dupont). Because of the grinding process, it is thus possible to use zeolites with precipitated instead of colloidal silicic acids, leading to significant cost reductions, as precipitated silicic acids are cheaper than colloidal silicic acids.

1. Method for synthesis of zeolites, comprising the following steps:
a) providing a silicon source;
b) providing an aluminium source;
c) mixing the silicon source and the aluminium source in order to produce a synthesis gel;
d) grinding the synthesis gel;
e) treating the ground synthesis gel under hydrothermal conditions in order to produce a crystalline zeolite.

2. Method according to claim 1, characterized in that the silicon source, the aluminium source, and the synthesis gel are present in an aqueous medium.

3. Method according to claim 1, characterized in that the silicon source comprises precipitated silicic acid.

4. Method according to claim 1, characterized in that the silicon source and the aluminium source are subjected to grinding.

5. Method according to claim 1, characterized in that the grinding is carried out with at least one grinding device, wherein the at least one grinding device is selected from the group consisting of a ball mill, an annular gap mill, a bead mill, a Manton-Gaulin mill, and combinations thereof.

6. Method according to claim 1, characterized in that the grinding is carried out at a pH in the range from approximately 9 to 14.

7. (canceled)

8. Method according to claim 1, characterized in that after treatment under hydrothermal conditions, the obtained crystalline zeolite is separated, dried and calcined.

9. Method according to claim 8, characterized in that the drying is carried out at a temperature of approximately 60 to 200° C., and the calcining at 250 to 750° C.

10. Method according to claim 1, characterized in that the average particle size d₅₀ of the synthesis gel after completion of the grinding is at least 10% smaller than the average particle size d₅₀ of the synthesis gel before the grinding.

11. Method according to claim 1, characterized in that the synthesis gel has a molar ratio of Al to Si in the range from 0.00125:1 to 0.1:1.

12. (canceled)

13. (canceled)

14. Zeolite that can be obtained according to a method according to claim 1, in particular MFI zeolite and beta zeolite.

15. Method for the synthesis of zeolites, comprising the following steps:
a) providing a silicon source;
b) providing an aluminium source;
c) providing one or more templates;
d) mixing the silicon source, the aluminium source, and the at least one template in order to produce a synthesis gel;
e) grinding the synthesis gel; and
f) treating the ground synthesis gel under hydrothermal conditions in order to produce a crystalline zeolite.

16. Method according to claim 15, characterized in that the silicon source, the aluminium source, the at least one template, and the synthesis gel are present in an aqueous medium.

17. Method according to claim 15, characterized in that the silicon source comprises precipitated silicic acid.

18. Method according to claim 15, characterized in that the silicon source and the aluminium source are subjected to grinding.

19. Method according to claim 15, characterized in that the grinding is carried out with at least one grinding device, wherein the at least one grinding device is selected from the group consisting of a ball mill, an annular gap mill, a bead mill, a Manton-Gaulin mill, and combinations thereof.

20. Method according to claim 15, characterized in that the grinding is carried out at a pH in the range from approximately 9 to 14.

21. Method according to claim 15, characterized in that the one or more templates is used in a quantity of 1 to 50 mol. %, relative to the molar quantity of Si in the silicon source.

22. Method according to claim 15, characterized in that the average particle size d₅₀ of the synthesis gel after completion of the grinding is at least 10% smaller than the average particle size d₅₀ of the synthesis gel before the grinding.

23. Method according to claim 15, characterized in that the synthesis gel has a molar ratio of Al to Si in the range from 0.00125:1 to 0.1:1.
